(19) United States
(12) Patent Application Publication
(10) Pub. No.: US 2023/0110088 A1
(43) Pub. Date: Apr. 13, 2023

(54) SYSTEMS AND METHODS FOR SCHEDULING WIRELESS CHANNEL ACCESS FOR REMOTE RENDERING

(71) Applicant: Meta Platforms Technologies, LLC, Menlo Park, CA (US)

(72) Inventors: Chittabrata GHOSH, Fremont, CA (US); Nabeel AHMED, San Jose, CA (US)

(21) Appl. No.: 17/943,886

(22) Filed: Sep. 13, 2022

Related U.S. Application Data
(60) Provisional application No. 63/255,241, filed on Oct. 13, 2021.

(51) Int. Cl. H04L 67/131

(52) U.S. Cl. CPC H04L 67/131

(57) ABSTRACT

A first device may include a transceiver and one or more processors. The one or more processors may wirelessly receive, via the transceiver from a second device, a first packet including image data and a trigger frame, the trigger frame including an identifier identifying the first device. The one or more processors may wirelessly transmit, via the transceiver to the second device, first sensor measurement data relating to the first device and acknowledgement (ACK), in response to the identifier identifying the first device in the trigger frame.

### CROSS-REFERENCE TO RELATED APPLICATION

This application claims priority to U.S. Provisional Patent Application No. 63/255,241 filed on Oct. 13, 2021, the content of which is incorporated by reference herein in its entirety for all purposes.

### FIELD OF DISCLOSURE

The present disclosure is generally related to providing a session or artificial reality such as a virtual reality (VR), an augmented reality (AR) or a mixed reality (MR), including but not limited to scheduling communication for remote rendering of the session or artificial reality.

### BACKGROUND

Artificial reality, such as a VR, AR, or MR, provides immersive experience to a user. In one example, a user wearing a head wearable device (HWD) can turn his head to one side, and an image of a virtual object corresponding to a location and/or an orientation of the HWD and a gaze direction of the user can be displayed on the HWD to allow the user to feel as if the user is moving within a space of an artificial reality (e.g., a VR space, an AR space, or a MR space).

In one implementation, an image of a virtual object is generated by a remote computing device communicatively coupled to the HWD, and the image is rendered by the HWD to conserve computational resources and/or achieve bandwidth efficiency. In one example, the HWD includes various sensors that detect a location and/or orientation of the HWD and a gaze direction of the user wearing the HWD, and transmits sensor measurements indicating the detected location and gaze direction to a console device (and/or a remote server, e.g., in the cloud) through a wired connection or a wireless connection. The console device can determine a user's view of the space of the artificial reality according to the sensor measurements, and generate an image of the space of the artificial reality corresponding to the user's view. The console device can transmit the generated image to the HWD, by which the image of the space of the artificial reality corresponding to the user's view can be presented to the user. In one aspect, the process of detecting the location of the HWD and the gaze direction of the user wearing the HWD, and rendering the image to the user should be performed within a frame time (e.g., less than 11 ms). Any latency between a movement of the user wearing the HWD and an image displayed corresponding to the user movement can cause judder, which may result in motion sickness and can degrade the user experience.

### SUMMARY

Various embodiments disclosed herein are related to a first device including a transceiver and one or more processors. The one or more processors may be configured to wirelessly receive, via the transceiver from a second device, a first packet including image data and a trigger frame, the trigger frame including an identifier identifying the first device. The one or more processors may be configured to wirelessly transmit, via the transceiver to the second device, first sensor measurement data relating to the first device and acknowledgement (ACK) to the first packet, in response to the identifier identifying the first device in the trigger frame.

In some embodiments, the first device may be a head wearable device (HWD) and the second device may be a console device. The first sensor measurement data may indicate a location or orientation of the HWD. In some embodiments, the transceiver may be configured to communicate with the second device using a peer-to-peer connection in a wireless network.

In some embodiments, the one or more processors may be configured to perform the wirelessly receiving and the wirelessly transmitting in a service period of a target wake time (TWT) schedule. The one or more processors may be configured to determine the service period, to operate the first device in a wake up mode, the service period encompassing a first duration to wirelessly receive the first packet and a second duration to wirelessly transmit the first sensor measurement data. The one or more processors may be configured to prior to receiving the first packet, enter at least a portion of the first device in the wake up mode. The one or more processors may be configured to enter the at least a portion of the first device in a sleep mode after the service period. The one or more processors may be configured to periodically receive, from the second device, a plurality of packets including the first packet, each of the plurality of packets including respective image data and a respective trigger frame in a respective service period. In response to the respective trigger frame, the one or more processors may be configured to transmit, to the second device, respective sensor measurement data relating to the first device in the respective service period, and enter the at least a portion of the first device in the wake up mode during the respective service period.

In some embodiments, the first packet is a high efficiency multi-user physical protocol data unit (HE MU PPDU). The trigger frame may include a resource unit (RU) associated with the identifier, such that the first device is triggered to transmit the first sensor measurement data in the RU.

In some embodiments, the one or more processors may be configured to associate the first device to the second device as an access point in a wireless local area network (WLAN). The one or more processors may be configured to wirelessly receive, via the transceiver from the second device, a clear-to-send (CTS) frame with a receiver address set to an address of the first device. The one or more processors may be configured to determine a third duration indicated in the CTS frame. The one or more processors may be configured to wirelessly transmit, via the transceiver to the second device during the third duration, second sensor measurement data relating to the first device.

Various embodiments disclosed herein are related to a method including wirelessly receiving, by a first device from a second device, a first packet including image data and a trigger frame, the trigger frame including an identifier identifying the first device. The method may include wirelessly transmitting, by the first device to the second device, first sensor measurement data relating to the first device and acknowledgement (ACK) to the first packet, in response to the identifier identifying the first device in the trigger frame.

In some embodiments, the first device may be a head wearable device (HWD) and the second device may be a console device. The first sensor measurement data may indicate a location or orientation of the HWD. In some embodiments, the first device may communicate with the second device using a peer-to-peer connection in a wireless network.

In some embodiments, the first device may perform the wirelessly receiving and the wirelessly transmitting in a service period of a TWT schedule. The first device may determine the service period, to operate the first device in a wake up mode, the service period encompassing a first duration to wirelessly receive the first packet and a second duration to wirelessly transmit the first sensor measurement data. Prior to receiving the first packet, the first device may enter the wake up mode. The first device may enter a sleep mode after the service period.

In some embodiments, the first device may periodically receive, from the second device, a plurality of packets including the first packet, each of the plurality of packets including respective image data and a respective trigger frame in a respective service period. In response to the respective trigger frame, the first device may transmit, to the second device, respective sensor measurement data relating to the first device in the respective service period. The first device may enter the wake up mode during the respective service period.

In some embodiments, the first packet may be/include a HE MU PPDU. The trigger frame may include a resource unit (RU) associated with the identifier, such that the first device is triggered to transmit the first sensor measurement data in the RU.

In some embodiments, the first device may associate to the second device as an access point in a wireless local area network (WLAN). The first device may wirelessly receive, from the second device, a clear-to-send (CTS) frame with a receiver address set to an address of the first device. The first device may determine a third duration indicated in the CTS frame. The first device may wirelessly transmit, to the second device during the third duration, second sensor measurement data relating to the first device.

Various embodiments disclosed herein are related to a head wearable device (HWD) including one or more processors. The one or more processors may be configured to receive, from a console, HE MU PPDU including image data of artificial reality and a trigger frame, the trigger frame including an identifier identifying the HWD. The one or more processors may be configured to transmit, to the console, sensor measurement data indicating a location or orientation of the HWD, in response to the identifier identifying the HWD in the trigger frame. HWD is referenced herein by way of illustration and not intended to be limiting in any way. Any device, such as a user/mobile/wearable device, can operate in place of the HWD described herein. Console is referenced herein by way of illustration and not intended to be limiting in any way. Any device, such as an access point (AP), a soft AP, a computing device or a router, can operate in place of the console described herein.

In some embodiments, the trigger frame may include the identifier identifying only the HWD. Only the one or more processors of the HWD may be configured to transmit the sensor measurement data, in response to the trigger frame. In some embodiments, the one or more processors may be configured to transmit different sensor measurement data periodically according to a first time interval. The console may be configured to transmit HE MU PPDUs including different image data periodically according to a second time interval, the second time interval being larger than the first time interval.

In some embodiments, the HWD may be configured to receive the HE MU PPDU during a time duration between i) a first time duration for the one or more processors to transmit additional sensor measurement data and ii) a second time duration for the one or more processors to transmit the sensor measurement data.

Various embodiments disclosed herein are related to a head wearable device (HWD) including one or more processors. The one or more processors may be configured to receive, from a console, a clear-to-send (CTS) frame including an address of the HWD. The one or more processors may be configured to transmit, to the console, sensor measurement data indicating a location or orientation of the HWD, in response to the address of the HWD in the CTS frame. The CTS frame includes the address of the HWD as a receiver address (RA). The CTS frame may prevent other devices from transmitting while the HWD transmits sensor measurement data to the console.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable device (HWD) or head mounted device (HMD), according to an example implementation of the present disclosure.

FIG. 3 is a block diagram of a computing environment according to an example implementation of the present disclosure.

FIG. 4A and FIG. 4B are diagrams depicting remote rendering from an AR/VR console or computing device to an AR/VR device, according to an example implementation of the present disclosure.

FIG. 5 is a diagram depicting a scheme for scheduling communication for remote rendering from an AR/VR console or computing device to an AR/VR device, according to an example implementation of the present disclosure.

FIG. 6 is a diagram depicting a scheme for scheduling communication for remote rendering from an AR/VR console or computing device to an AR/VR device, according to an example implementation of the present disclosure.

FIG. 7 is a flowchart showing a process of remote rendering from an AR/VR console or computing device to an AR/VR device, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are related to systems, devices and methods for scheduling communication for remote rendering of artificial reality by a first device (e.g., HMD, HWD) including a transceiver and one or more processors. The one or more processors may wirelessly receive, via the transceiver from a second device (e.g., AR/VR console, PC, AP, smartphone, or soft AP), a first packet including image/video data (e.g., AR/VR rendering data) and a trigger frame. The trigger frame may include an identifier identifying the first device. The one or more processors may wirelessly transmit, via the transceiver to the second device, first sensor measurement data relating to the first device (e.g., pose and/or inertial measurement unit (IMU) data) and acknowledgement (ACK) to the first packet, in response to the identifier identifying the first device in the trigger frame.

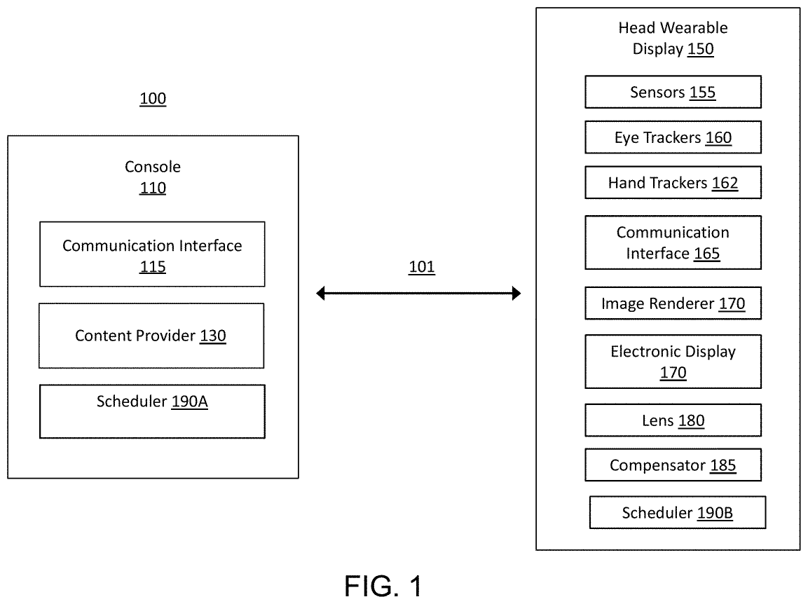

FIG. 1 is a block diagram of an example artificial reality system environment 100 in which a console 110 operates. In some embodiments, the artificial reality system environment 100 includes a HWD 150 worn by a user, and a console 110 providing content of artificial reality to the HWD 150. The console 110 may be a computing device or a remote (cloud) server operating in conjunction with a computing device. A head wearable device (HWD) may be referred to as, include, or be part of a head mounted display (HMD), head mounted device (HMD), head wearable device (HWD), head worn display (HWD) or head worn device (HWD). In one aspect, the HWD 150 may detect its location and/or orientation, and a gaze direction of the user wearing the HWD 150, and provide the detected location and/or orientation, and the gaze direction to the console 110. The console 110 may determine a view within the space of the artificial reality corresponding to the detected location and/or orientation and the gaze direction, and generate an image depicting the determined view. The console 110 may provide the image to the HWD 150 for rendering. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150. For example, some of the functionality of the HWD 150 may be performed by the console 110. In some embodiments, the console 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, a communication interface 165, an adaptive image renderer 170, an electronic display 175, a lens 180, and a compensator 185. These components may operate together to detect a location and an orientation of the HWD 150 and/or a gaze direction of the user wearing the HWD 150, and render an image of a view within the artificial reality corresponding to the detected location and orientation of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and/or location of the HWD 150. In one aspect, the sensors 155 can detect the translational movement and the rotational movement with respect to a previous orientation and/or location of the HWD 150, and determine a new orientation and location of the HWD 150 by accumulating or integrating the detected translational movement and/or the rotational movement. Assuming for example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors include 155 include one or more eye trackers. An eye tracker may include electronic components or a combination of electronic components and software components that determine a gaze direction of the user of the HWD 150. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gate direction of the user. Assuming for example that the HWD 150 is oriented at a direction 30 degrees from a reference direction, and the relative gaze direction of the HWD 150 is −10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers. In some embodiments, a user of the HWD 150 is prompted to enable or disable the eye trackers.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In the embodiments, in which the console 110 and the head wearable device 150 are implemented on a single system, the communication interface 165 may communicate with the console 110 through a bus connection or a conductive trace. Through the communication link, the communication interface 165 may transmit to the console 110 data (e.g., sensor measurements) indicating the determined location of the HWD 150 and the determined gaze direction of the user. In addition, through the communication link, the communication interface 165 may transmit to the console 110 any feedback information. Moreover, through the communication link, the communication interface 165 may receive from the console 110 image data indicating image to be rendered.

In some embodiments, the adaptive image renderer 170 includes an electronic component or a combination of an electronic component and a software component that generates one or more images for display, for example, according to a change in view of the artificial reality. In some embodiments, the adaptive image renderer 170 is implemented as a processor (or a graphical processing unit (GPU)) that executes instructions to perform various functions described herein. The adaptive image renderer 170 may receive, through the communication interface 165, image data describing an image to be rendered, and render the image through the electronic display 175. In some embodiments, the data from the console 110 may be compressed and/or encoded, and the adaptive image renderer 170 may decompress and/or decode the image data to generate and render the image. In one aspect, the process of detecting, by the HWD 150, the location and the orientation of the HWD 150 and/or the gaze direction of the user wearing the HWD 150, and generating and transmitting, by the console 110, a high resolution image (e.g., 1920 by 1080 pixels) corresponding to the detected location and the gaze direction to the HWD 150 may be computationally exhaustive and may not be performed within a frame time (e.g., less than 11 ms). In one aspect, the adaptive image renderer 170 generates an image frame through an image processing (e.g., a time warp processing and/or a reprojection) performed on an image frame from the console 110 to generate an updated image frame corresponding to updated sensor measurements. For example, the time warp process and/or the reprojection may be performed on the image frame to reuse a portion of the image frame to generate the updated image frame of a view of the artificial reality corresponding to the updated sensor measurements. Hence, a communication bandwidth between the console 110 and the HWD 150 can be reduced, and a high resolution image can be presented to the user without sacrificing fidelity.

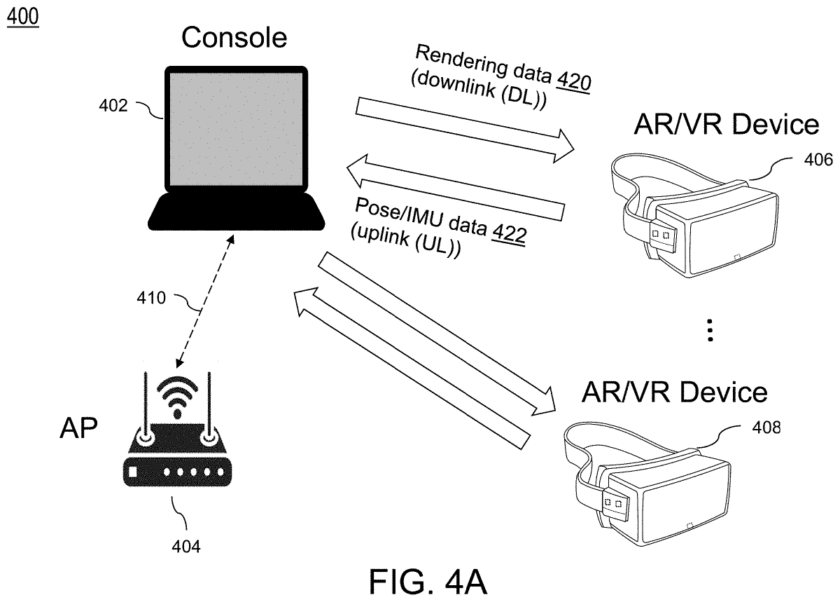

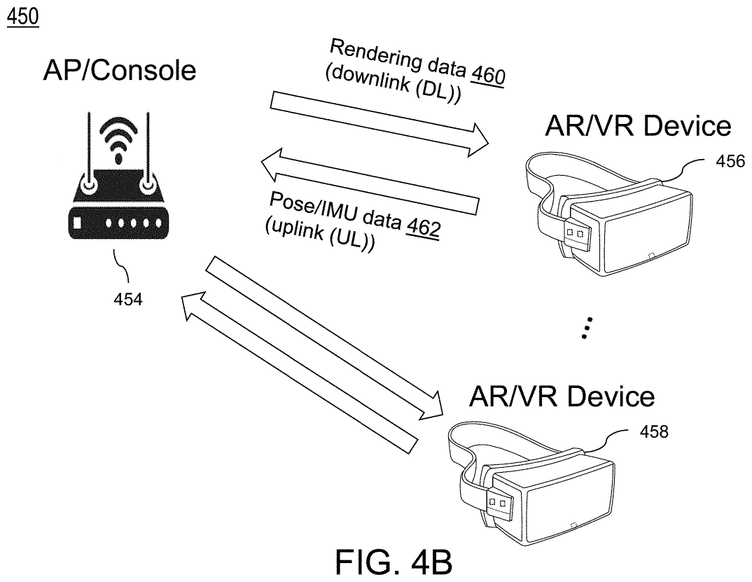

In some embodiments, the adaptive image renderer 170 generates feedback information indicating a completion time, at which image processing (e.g., time warp and/or a reprojection) is completed, and/or a decoding time, at which decoding of the image data is completed, and provide the feedback information to the console 110 through the communication interface 165. In one aspect, the feedback information provided to the console 110 causes the console 110 to adjust the timing of generating image data of an image frame. Such adjusted timing causes or allows the adaptive image renderer 170 to decode the image data to obtain an image frame, and perform image processing (e.g., time warp and/or reprojection) on the image frame according to updated sensor measurements to generate the updated image frame at a completion time close (e.g., within 1 ms) to the display time, at which the updated image frame is displayed. Hence, a latency between the movement of the user and the image displayed corresponding to the user movement can be adaptively adjusted. Detailed description on configurations and operations of the adaptive image renderer 170 are provided below with respect to FIGS. 4 through 7.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes, for example through a lens, according to image generated by the adaptive image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the adaptive image renderer 170 to compensate for the distortions caused by the lens 180, and apply the determined compensation to the image from the adaptive image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and an adaptive image generator 130. These components may operate together to determine a view of the artificial reality corresponding to the location of the HWD 150 and the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150.

In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link. Through the communication link, the communication interface 115 may receive from the HWD 150 data (e.g., sensor measurements) indicating the determined location and orientation of the HWD 150 and/or the determined gaze direction of the user. Moreover, through the communication link, the communication interface 115 may transmit to the HWD 150 image data describing an image to be rendered. In addition, through the communication link, the communication interface 115 may receive feedback information from the HWD 150.

The adaptive image generator 130 corresponds to or includes a component that generates content to be rendered according to the location and orientation of the HWD 150 and/or the gaze direction of the user of the HWD 150. In one aspect, the adaptive image generator 130 determines a view of the artificial reality according to the location and orientation of the HWD 150 and/or the gaze direction of the user of the HWD 150. For example, the adaptive image generator 130 maps the location of the HWD 150 in a physical space to a location within a virtual space, and determines a view of the virtual space along a direction corresponding to the orientation of the HWD 150 and the gaze direction of the user from the mapped location in the virtual space. The adaptive image generator 130 may generate an image frame describing an image of the determined view of the virtual space, and can transmit the image frame to the HWD 150 through the communication interface 115. The adaptive image generator 130 may compress and/or encode the image frame to generate an image data encoding the image frame, and can transmit the compressed and/or encoded image data to the HWD 150.

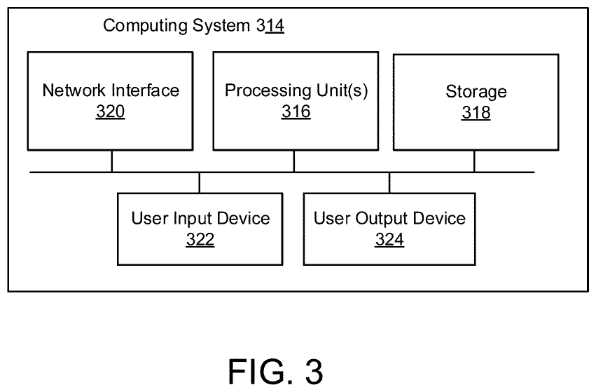

In some embodiments, the adaptive image generator 130 receives feedback information from the HWD 150, and can adaptively generate the image data according to the feedback information. In one aspect, the feedback information indicates a completion time, at which the image frame is generated by the HWD 150 for display. The adaptive image generator 130 may determine whether the completion time is within a predetermined range from a display time, at which the image frame displayed by the HWD 150. According to the comparison, the adaptive image generator 130 may generate image data for another image frame. For example, if the completion time is not within a predetermined range from the display time, the adaptive image generator 130 may determine an amount of time to delay or expedite (or hasten) the completion time to allow the adjusted completion time to be within the predetermined range from the display time. Then, the adaptive image generator 130 may adjust an image processing performed according to the determined amount of time to delay or expedite (or hasten) to generate another image frame, and encode the image frame to generate the image data. In one aspect, the adjusted image processing by the adaptive image generator 130 causes or allows the HWD 150 to receive the image data and generate an image frame based on the image data at another completion time via additional or extended image processing (e.g., time warp processing and/or reprojection) within a predetermined range from another display time. Hence, a latency between the movement of the user and the image displayed corresponding to the user movement can be adaptively adjusted. Detailed description on configurations and operations of the adaptive image generator 130 are provided below with respect to FIGS. 3 and 5 through 7.

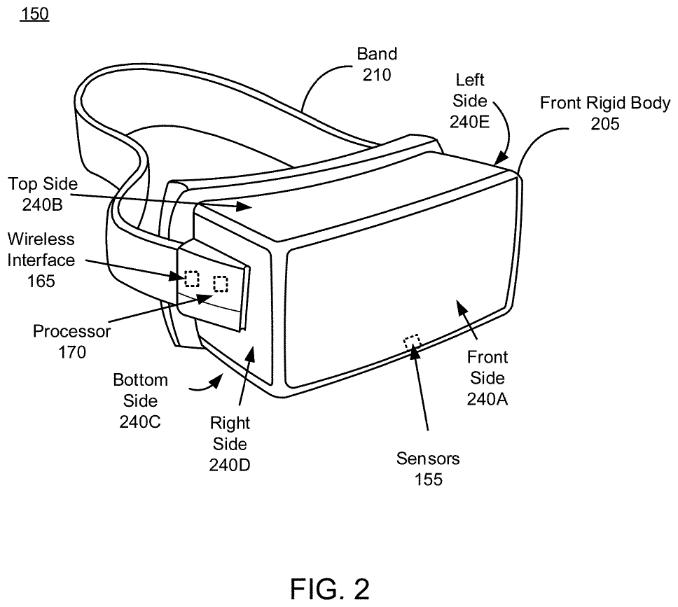

FIG. 2 is a diagram of the HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, and the adaptive image renderer 170. In the embodiment shown by FIG. 2, the sensors 155 are located within the front rigid body 205, and the sensors 155 are not visible to the user. In other embodiments, the HWD 150 has a different configuration than shown in FIG. 2. For example, the adaptive image renderer 170, and/or the sensors 155 may be in different locations than shown in FIG. 2.

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable device), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

FIG. 4A and FIG. 4B are diagrams depicting remote rendering from an AR/VR console or compute device to an AR/VR device, according to an example implementation of the present disclosure. In one scenario of remote rendering, an AR/VR console (e.g., a computing device, PC, Wi-Fi station (STA), smartphone, soft access point, etc.) may perform remote rendering to an AR/VR device (e.g., HMD, HWD) by sending/transmitting/communicating rendering data to the AR/VR device wirelessly (e.g., in a peer-to-peer mode). For example, in a configuration 400 depicted in FIG. 4A, an AR/VR console 402 (or a computing device, PC, Wi-Fi station (STA), soft access point, etc.) may communicate 410 with an AP 404 in a WLAN while sending/transmitting/communicating video/rendering data 420 (as downlink (DL) data) to an AR/VR device 406. The device 406 may send/transmit/communicate pose and/or inertial measurement unit (IMU) data 422 (as uplink (UL) data) to the console 402. The console 402 may enable a client interface (e.g., WLAN network interface) to the AP. In some embodiments, the console 402 may serve as a peer-to-peer (P2P) device in a P2P network (e.g. Wi-Fi Direct, Wi-Fi Aware) to communicate with the device 406. In some embodiments, the console 402 may serve as a soft access point or a Group Owner (in Wi-Fi Direct) in a WLAN to communicate with the device 406 acting as a Group Client in one embodiment (in Wi-Fi Direct). In some embodiments, the console 402 may enable a P2P mode of operation or a soft access point of operation for communication between the console 402 and the device 406. In some embodiments, there may be other AR/VR devices (e.g., device 408) with each of which the console 402 may communicate in a manner similar to that of communicating with the device 406. Although the disclosure may sometimes describe AR/VR applications/scenarios, these are illustrative in nature, such that non-AR/VR applications/scenarios are similarly supported by the present systems and methods.

In another scenario of remote rendering, in a configuration 450 in FIG. 4B, an AP 454 as an AR/VR console may send/transmit/communicate video/rendering data 460 (as DL data) to an AR/VR device 456. The device 456 may send/transmit/communicate pose and/or IMU data 462 (as UL data) to the AP 454. The AP 454 may serve as a peer-to-peer (P2P) device in a P2P network (e.g. Wi-Fi Direct) to communicate with the device 456. In some embodiments, the AP 454 may enable a P2P mode of operation for communication between the AP 454 and the device 456. In some embodiments, data rendered in a cloud or server may be provided to the AP 454 which sends/transmits/communicates the data to the device 456. In some embodiments, there may be other AR/VR devices (e.g., device 458) with each of which the AP 454 may communicate in a manner similar to that of communicating with the device 456.

One problem/challenge in remote rendering relates to optimizing a wireless link or medium for low-latency rendering when there are multiple devices sharing the wireless link or medium. It may be beneficial to schedule communications between an AR/VR console (e.g., console 402, or AP 454) and an AR/VR device (e.g., HWD 406, 456) for reduced latency when the AR/VR device receives DL data (e.g., video/rendering data) through the wireless link while transmitting UL data (e.g., IMU/pose data). For example, the AR/VR device may transmit, to the console, sensor measurement data (e.g., pose/IMU data 422, 462) indicating a location and/or orientation of the AR/VR device. In some embodiments, the console may act/operate as a soft access point (soft AP) to receive the sensor measurement data, and can generate image data of AR/VR image corresponding to the location and/or orientation of the AR/VR device. The console may transmit the image/video data (or other types(s) of downlink (DL) data) to the AR/VR device, every frame time or refresh rate (e.g., 11 ms or 16 ms at 90 or 60 Hz, respectively). The AR/VR device can receive the image data, and can present an AR/VR image to the user. In some cases, a Wi-Fi channel link is based on contention, such that transmission by the console (downlink), transmission by the AR/VR device (uplink), and/or transmission(s) by other devices, may collide. Collisions of transmissions by the console, the AR/VR device, and/or other devices may cause increased latency of communication between the console and the AR/VR device.

To solve these problems, according to certain aspects, embodiments in the present disclosure relate to techniques for scheduling communications between an AR/VR console (e.g., computing device, PC, STA, soft AP, or AP) and an AR/VR device (e.g., HMD, HWD) for reduced latency by setting a predefined time period/interval (e.g., service period of a TWT schedule) during which the console can both send DL video/rendering data to the AR/VR device and receive UL pose/IMU data from the AR/VR device. Embodiments in the present disclosure can also relate to techniques for reducing power consumption in remote rendering by efficiently setting a TWT schedule and its service period (SP) during which the AR/VR device can operate in a wake up mode to perform both receiving of DL rendering data from the console and sending UL pose/IMU data to the console, and then enter a sleep mode after the SP (e.g., instead of using or switching between multiple wake up periods and sleep periods).

Embodiments of the present systems, devices and methods are applicable to (e.g., AR/VR Wi-Fi-related) wireless communications between glasses/HMD/HWD and its counterpart device (console/PC in some systems; or router/access point, in other systems where content for rendering are to be generated in the cloud/network/remote-server). The systems, devices and methods can use or incorporate mechanisms that are designed/configured to coordinate DL data (e.g., video/rendering data) and UL data (e.g., pose/IMU data) scheduling to minimize latency between these uplink/downlink (UL/DL) transmissions, and also to avoid channel contention from other devices in the same wireless/Wi-Fi space. These can include coordinating TWT (e.g., individual TWT) schedules to handle both UL and DL data at specific cycles and/or intervals for power savings and efficiency, and can also use triggers to enable a specific HMD to perform UL transmission while quietening other devices in the vicinity to avoid contention. At least two approaches/embodiments can cover the scenarios where UL data and DL data are dependent with each other (e.g. scheduled within a defined proximity in time with each other) or independent from each other.

In a first scenario, when UL data and DL data are dependent with each other such that both data can be scheduled within a defined proximity in time with each other, in a case in which there are multiple AR/VR devices receiving the DL data from the console, HE multi-user (MU) PPDUs may be used to (1) carry the DL data (e.g., video/rendering data) and (2) contain a trigger frame trigger the AR/VR device (e.g., HWD) to send UL data. For example, UL data may be close together with (or dependent with) DL data such that the UL data occurs or is generated/scheduled within 16 μs or a short inter-frame space (SIFS) time/duration period from the DL data. The DL data carried by HE MU PPDUs may be sent/transmitted/communicated from the AR/VR console to the AR/VR device every 11.1 ms (90 Hz) or 16.66 ms (60 Hz) for instance, or a corresponding duration equivalent to frequency of video packet generation at specific refresh rates. In other words, the inter-arrival time of the DL data may be 11.1 ms (90 Hz) or 16.66 ms (60 Hz). UL data (e.g., sensor measurement data or pose/IMU data) may sent/transmitted/communicated from the AR/VR device to the console every 2 ms (500 Hz) for example. In other words, the inter-arrival time of the UL data may be 2 ms (500 Hz), which is a smaller cycle/insterval than that of the DL data. The duration of sending/transmitting/communicating the DL data may be smaller than the inter-arrival time of the UL data. For example, the duration of DL data transmission is 1.80 ms. The duration of sending/transmitting/communicating the UL data may be smaller than that of the DL data. For example, the duration of UL data transmission is 148 μs.

The HE MU PPDU may contain a trigger frame for use in unicast communication. The trigger frame may include/specify an association ID (AID) to target or identify the AR/VR device so that the AR/VR device is triggered to perform transmission of UL data. In some embodiments, the trigger frame may include information relating to allocation/assignment of a resource unit (RU) for the AR/VR device so that the AR/VR device sends the UL data in the allocated/assigned RU as a high efficiency trigger-based physical protocol data unit (HE TB PPDU). The HE TB PPDU may include an acknowledgement (ACK) and the UL data so as to avoid channel contention processes (e.g., Wi-Fi channel contention process) since no other device or station (STA)'s AID is identified in the MU PPDU to trigger transmission of the UL data. The HE TB PPDU including the UL data may be transmitted after a short inter-frame space (SIFS) time/duration has elapsed after completion of the transmission of the DL data.

In some embodiments, in a case in which there is a single AR/VR device receiving the DL data from the console, HE single-user (SU) PPDUs may be used to (1) carry the DL data (e.g., video/rendering data) and (2) contain a trigger frame to trigger the AR/VR device (e.g., HWD) to send UL data.

In some embodiments, communication between an AR/VR console (e.g., console 402 or AP 454) and an AR/VR device (e.g., HWD 406, 456, or glasses or AR/VR rendering/display device) may be scheduled utilizing Wi-Fi (e.g., 802.11ax) features. The console may transmit image data utilizing a HE MU PPDU (e.g., conforming to IEEE 802.11 ax). The console may include a trigger frame within the HE MU PPDU with an association identifier (AID) indicating/identifying/specifying the HWD. This allows only the HWD to bypass the contention procedure and respond to the trigger frame with the sensor measurement data (or pose/IMU data). Accordingly, the HWD may transmit sensor measurement data shortly or within a predefined period (e.g., 16 μs of SIFS time/duration) from the end of downlink transmission of image data by the AR/VR console.

In some embodiments, when UL data and DL data are dependent with (or related to) each other such that both data can be scheduled within a defined proximity in time with each other, an agreement on an individual TWT schedule can be negotiated or put in place between the console (e.g., PC, soft AP, AP) and the AR/VR device (e.g., HMD, HWD) so that the AR/VR device can periodically and efficiently enter a wake up mode to receive the DL data and transmit the UL data simultaneously. The UL PPDU may comprise the pose/IMU data and the ACK (acknowledgement) of the received DL PPDU. In some embodiments, the agreement on the individual TWT schedule can be made such that (1) a TWT interval of the TWT schedule may be set to the inter-arrival time of the DL data and (2) TWT service period (SP) of the TWT schedule may be set to a value smaller than or equal to a duration such that the AR/VR device can handle both reception of the DL data and transmission of the UL data during the SP duration. For example, when the inter-arrival time of DL data is 11.1 ms or 16.66 ms, the inter-arrival time of UL data is 2 ms, and the duration of the DL data is 1.80 ms, the TWT interval of the TWT schedule may be set to 11.1 ms or 16.66 ms (e.g., refresh rate of rendering data) or an interval value equivalent/corresponding to the frequency of video packet generation; and the TWT SP duration of the TWT schedule may be set to 1.85 ms (or a value closer to but smaller than 2 ms), so that the AR/VR device can periodically operate in a wake-up mode as scheduled according to the TWT schedule to handle both reception of the DL data and transmission of the UL data during the SP duration. For example, if the SP duration is set to 1.85 ms, the AR/VR device can enter the wake-up mode at the start of transmission of the DL data and handle (e.g., receive) the DL data and the trigger frame (included in HE MU PPDU) during 1.80 ms such that the device can be triggered to perform transmission of the UL data (the duration of which is only 148 μs) with ACK to the received HE MU PPDU as a HE TB PPDU shortly after or within a predefined period (e.g., 16 μs of SIFS time/duration) from the end of DL transmission. In this manner, the AR/VR device can handle both reception of the DL data and transmission of the UL data during the same SP duration (e.g., 1.85 ms). The HE TB PPDU may be transmitted in a resource unit (e.g., frequency allocation of 20 MHz or 256 tones) indicated in the trigger frame (included in the HE MU PPDU) from the soft AP, PC, or AP.

In a second scenario, when UL data and DL data are independent from (e.g., unrelated to) each other such that transmission of the UL data may not overlap nor be close to transmission of the DL data, the console may transmit a clear-to-send (CTS) frame or a CTS-to-self frame to the AR/VR device to avoid collision/contention of the device with other STAs for data transmissions or channel access. For example, UL data (e.g., sensor measurement data or pose/IMU data) may sent/transmitted/communicated from the AR/VR device to the console every 2 ms (500 Hz) in a manner that transmission of the UL data is independent with transmission of DL data.

In some embodiments, in a case in which the console and AR/VR devices share a wireless medium or channel in a basic service set (BSS), the console (e.g., soft AP) may send a CTS or a CTS-to-self frame with a receiver address (RA) that is set to a particular device's address only, to quiet the BSS. For example, upon sending a CTS frame or a CTS-to-self frame, other devices in the vicinity except the particular device cannot access the shared channel/medium, so as to avoid collision/contention with the other devices for transmissions and/or channel access. In some embodiments, the console may transmit a CTS frame or a CTS-to-self frame to reserve a time period (e.g., an expected time period) for the particular device to transmit sensor measurement data by indicating the time period in a NAV. The CTS frame or the CTS-to-self frame may include a specific address of the particular device as a receiver address (RA), such that other devices would remain quiet and not transmit for the time period. Hence, the particular device may transmit the sensor measurement data during the time period without competing/contending with other devices.

For example, prior to (or in preparation for) the time (e.g., every 2 ms) for UL data transmission from the particular AR/VR device, the particular device does not set its NAV based on the CTS/CTS-to-self frame sent by the console, because the particular device is to be ready to transmit the UL data. On the other hand, all other AR/VR devices (or STAs) associated with the console (e.g., soft AP) shall set their NAVs for a duration indicated in the CTS frame or the CTS-to-self frame so as not to collide or contend with the particular device for transmission or channel access during that duration.

According to certain aspects, embodiments in the present disclosure relate to techniques for a first device including a transceiver and one or more processors. The one or more processors may wirelessly receive, via the transceiver from a second device, a first packet including image data and a trigger frame, the trigger frame including an identifier identifying the first device. The one or more processors may wirelessly transmit, via the transceiver to the second device, first sensor measurement data relating to the first device and acknowledgement (ACK) to the first packet, in response to the identifier identifying the first device in the trigger frame.

In some embodiments, the first device may be a head wearable device (HWD) and the second device may be a console device. The first sensor measurement data may indicate a location or orientation of the HWD. In some embodiments, the transceiver may be configured to communicate with the second device using a peer-to-peer connection in a wireless network.

In some embodiments, the one or more processors may be configured to perform the wirelessly receiving and the wirelessly transmitting in a service period of a TWT schedule. The one or more processors may be configured to determine the service period, to operate the first device in a wake up mode, the service period encompassing a first duration to wirelessly receive the first packet and a second duration to wirelessly transmit the first sensor measurement data. The one or more processors may be configured to, prior to receiving the first packet, enter at least a portion of the first device in the wake up mode. The one or more processors may be configured to enter the at least a portion of the first device in a sleep mode after the service period. The one or more processors may be configured to periodically receive, from the second device, a plurality of packets including the first packet, each of the plurality of packets including respective image data and a respective trigger frame in a respective service period. In response to the respective trigger frame, the one or more processors may be configured to transmit, to the second device, respective sensor measurement data relating to the first device in the respective service period, and enter the wake up mode during the respective service period.

In some embodiments, the first packet is a high efficiency multi-user physical protocol data unit (HE MU PPDU). The trigger frame may include a resource unit (RU) associated with the identifier, such that the first device is triggered to transmit the first sensor measurement data in/using the RU.

In some embodiments, the one or more processors may be configured to associate the first device to the second device as an access point in a wireless local area network (WLAN). The one or more processors may be configured to wirelessly receive, via the transceiver from the second device, a clear-to-send (CTS) frame with a receiver address set to an address of the first device. The one or more processors may be configured to determine a third duration indicated in the CTS frame. The one or more processors may be configured to wirelessly transmit, via the transceiver to the second device during the third duration, second sensor measurement data relating to the first device.

According to certain aspects, embodiments in the present disclosure relate to techniques for a head wearable device (HWD) including one or more processors. The one or more processors may be configured to receive, from a console, HE MU PPDU including image data (or other type(s) of data) of artificial reality and a trigger frame, the trigger frame including an identifier identifying the HWD. The one or more processors may be configured to transmit, to the console, sensor measurement data indicating a location or orientation of the HWD, in response to the identifier identifying the HWD in the trigger frame. HWD is referenced herein by way of illustration and not intended to be limiting in any way. Any device, such as a user/mobile/wearable device, can operate in place of the HWD described herein. Console is referenced herein by way of illustration and not intended to be limiting in any way. Any device, such as an access point (AP), a soft AP, a computing device or a router, can operate in place of the console described herein.

In some embodiments, the trigger frame may include the identifier identifying only the HWD. Only the HWD may be configured to transmit the sensor measurement data, in response to the trigger frame.

In some embodiments, the one or more processors may be configured to transmit different sensor measurement data periodically according to a first time interval. The console may be configured to transmit HE MU PPDUs including different image data periodically according to a second time interval, the second time interval being larger than the first time interval.

In some embodiments, the HWD may be configured to receive the HE MU PPDU during a time duration between i) a first time duration for the one or more processors to transmit additional sensor measurement data and ii) a second time duration for the one or more processors to transmit the sensor measurement data.

According to certain aspects, embodiments in the present disclosure relate to techniques for head wearable device (HWD) including one or more processors. The one or more processors may be configured to receive, from a console, a clear-to-send (CTS) frame including an address of the HWD. The one or more processors may be configured to transmit, to the console, sensor measurement data indicating a location or orientation of the HWD, in response to the address of the HWD in the CTS frame. The CTS frame includes the address of the HWD as a receiver address (RA). The CTS frame may prevent other devices from transmitting while the HWD transmits sensor measurement data to the console.

Embodiments in the present disclosure have at least the following advantages and benefits.

First, embodiments in the present disclosure can provide useful techniques for providing a mechanism for an AR/VR console (e.g., PC, AP, soft AP) and an AR/VR device (e.g., HMD, HWD) to schedule communications for reduced latency by setting a predefined time period/interval (e.g., service period of a TWT schedule) during which the console can both efficiently send DL rendering data to the AR/VR device and receive sensor measurement data (e.g., UL pose/IMU data) from the AR/VR device. The console may set a trigger frame in a HE MU PPDU of the rendering data with an association identifier (AID) indicating/identifying/specifying the AR/VR device. This allows only the AR/VR device to bypass the contention procedure and respond to the trigger frame with the UL pose/IMU data. Accordingly, the AR/VR device may transmit sensor measurement data shortly or within a predefined time from the end of DL transmission of the rendering data by the console. The console also can transmit a CTS frame or a CTS-to-self frame to reserve a time period (e.g., time period indicated by NAV) for the AR/VR device to transmit sensor measurement data. The CTS frame or the CTS-to-self frame can include a specific address of AR/VR device as a receiver address, such that other devices would remain quiet and not transmit for the time period. Hence, the AR/VR device can transmit the sensor measurement data during the time period without competing/contending with other devices. In this manner, the systems, devices and methods according to embodiments in the present disclosure can use or incorporate mechanisms that are designed/configured to coordinate DL data and UL data scheduling to minimize latency between these uplink/downlink (UL/DL) transmissions, and also to avoid contention from other devices in the same wireless/Wi-Fi space.

Second, embodiments in the present disclosure can provide useful techniques for providing a mechanism for an AR/VR device (e.g., HMD, HWD) to reduce power consumption in remote rendering by setting a TWT schedule and its service period (SP) during which the AR/VR device can operate/stay in a wake up mode to perform both receiving of DL rendering data from an AR/VR console (e.g., computing device, PC, STA, AP, soft AP) and sending UL pose/IMU data to the console, and then enter a sleep mode after the SP.

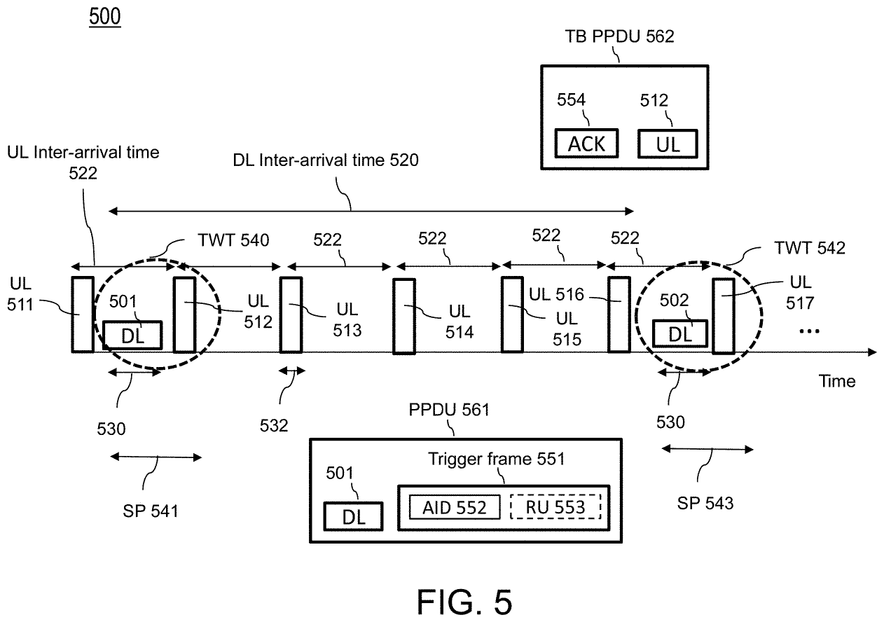

FIG. 5 is a diagram depicting a scheme for scheduling communication for remote rendering from an AR/VR console (e.g., console 404, AP/console 454) to an AR/VR device (e.g., device 406, 456), according to an example implementation of the present disclosure. FIG. 5 shows a scheduling scheme 500 in a first scenario in which DL data 501, 502 (e.g., data transmitted by console 404, 454 to device 406, 456) and at least some of the UL data 511, 512, 513, 514, 515, 516, 517 (e.g., data transmitted by device 406, 456 to console 404, 454) are dependent with each other such that both UL and DL data can be scheduled within a defined proximity in time with each other. For example, as shown in FIG. 5, the DL data 501 and the UL data 512 are scheduled within a proximity in time with each other, such that both the DL data 501 and the UL data 512 are scheduled to be close to each other within a duration of the UL inter-arrival time 522 (e.g., 2 ms).

In some embodiments, in a case in which there are multiple AR/VR devices (e.g., device 408, 458) receiving the DL data from the console, HE multi-user (MU) PPDUs may be used to (1) carry the DL data (e.g., video/rendering data) and (2) contain a trigger frame to trigger the AR/VR device (e.g., HWD) to send UL data. For example, the console 402, 454 may send a HE MU PPDU 561 carrying the DL data 501 and a trigger frame 551, to the AR/VR device 406, 456. In some embodiments, UL data 512 may be close together with (or dependent with) DL data 501 such that the UL data 512 occurs or is generated/scheduled within 16 μs or a SIFS time/duration period. The DL data carried by HE MU PPDUs may be sent/transmitted/communicated from the AR/VR console to the AR/VR device every 11.1 ms (90 Hz) or 16.66 ms (60 Hz) for instance, or corresponding duration equivalent to frequency of video packet generation. In other words, the inter-arrival time 520 of the DL data may be 11.1 ms (90 Hz) or 16.66 ms (60 Hz). UL data (e.g., sensor measurement data or pose/IMU data) may sent/transmitted/communicated from the AR/VR device to the console every 2 ms (500 Hz) for example. In other words, the inter-arrival time 522 of the UL data may be 2 ms (500 Hz), which is smaller than that of the DL data. The duration of sending/transmitting/communicating the DL data (e.g., duration 530) may be smaller than the inter-arrival time 522 of the UL data. For example, the duration 530 of DL data transmission is 1.80 ms which is smaller than 2 ms. The duration of sending/transmitting/communicating the UL data (e.g., duration 532) may be smaller than that of the DL data. For example, the duration 532 of UL data transmission is 148 μs.

The HE MU PPDU 561 may contain a trigger frame 551 for use in unicast communication. The trigger frame 551 may include/specify an association ID (AID) 552 to target or identify the (intended/desired) AR/VR device so that the AR/VR device is triggered to perform transmission of UL data. In some embodiments, the trigger frame 551 may include information relating to allocation/assignment of a resource unit (RU) 553 for the AR/VR device so that the AR/VR device sends the UL data in the allocated/assigned RU as a high efficiency trigger-based physical protocol data unit (HE TB PPDU) 562. The HE TB PPDU 562 may include an acknowledgement (ACK) 554 and the UL data 512 so as to avoid channel contention processes (e.g., Wi-Fi channel contention process) since no other device or station (STA)'s AID is identified in the MU PPDU to trigger transmission of the UL data. The HE TB PPDU including the UL data may be transmitted after a SIFS time/duration has elapsed after completion of the transmission of the DL data.

In some embodiments, when UL data and DL data are dependent such that both data can be scheduled within a duration of the inter-arrival time of UL data (as shown in FIG. 5), an agreement on an individual TWT schedule (e.g., TWT schedule 540, 542) can be negotiated or put in place between the console and the AR/VR device so that the AR/VR device can periodically enter a wake up mode to receive the DL data and transmit the UL data simultaneously. The UL PPDU may comprise the pose/IMU data and the ACK (acknowledgement) of the received DL PPDU. As shown in FIG. 5, the AR/VR device may periodically (with a defined TWT interval) enter a wake up mode according to the TWT schedule 540, 542 during the respective TWT service period (SP) 541, 543. In some embodiments, the agreement on the individual TWT schedule can be made such that (1) a TWT interval of the TWT schedule is set to the inter-arrival time 520 of the DL data and (2) TWT SP of the TWT schedule is set to a value smaller than a duration such that the AR/VR device can handle both reception of the DL data and transmission of the UL data during the SP duration. For example, when the inter-arrival time 520 of DL data is 11.1 ms or 16.66 ms, the inter-arrival time 522 of UL data is 2 ms, and the duration 530 of the DL data is 1.80 ms, the TWT interval of the TWT schedule may be set to 11.1 ms or 16.66 ms; and the TWT SP duration 541, 543 of the TWT schedule 540, 542 may be set to 1.85 ms (or a value closer to but smaller than 2 ms), so that the AR/VR device can periodically operate in a wake-up mode as scheduled according to the TWT schedule to handle both reception of the DL data 501 and transmission of the UL data 512 during the same SP duration 541. For example, if the SP duration is set to 1.85 ms, the AR/VR device can enter the wake-up mode at the start of transmission of the DL data 501 and handle (e.g., receive) the DL data 501 and the trigger frame 551 (included in HE MU PPDU 561) during 1.80 ms such that the device can triggered to perform transmission of the UL data (the duration 532 of which is only 148 μs) with ACK to the received HE MU PPDU as a HE TB PPDU 562 shortly after or within a predefined period (e.g., 16 μs of SIFS time/duration) from the end of DL transmission. In this manner, the AR/VR device can handle both reception of the DL data 501 and transmission of the UL data 512 during the same SP duration (e.g., 1.85 ms). The HE TB PPDU may be transmitted in a resource unit (e.g., frequency allocation of 20 MHz or 256 tones) indicated in the trigger frame (included in the HE MU PPDU) from the soft AP, PC, or AP.

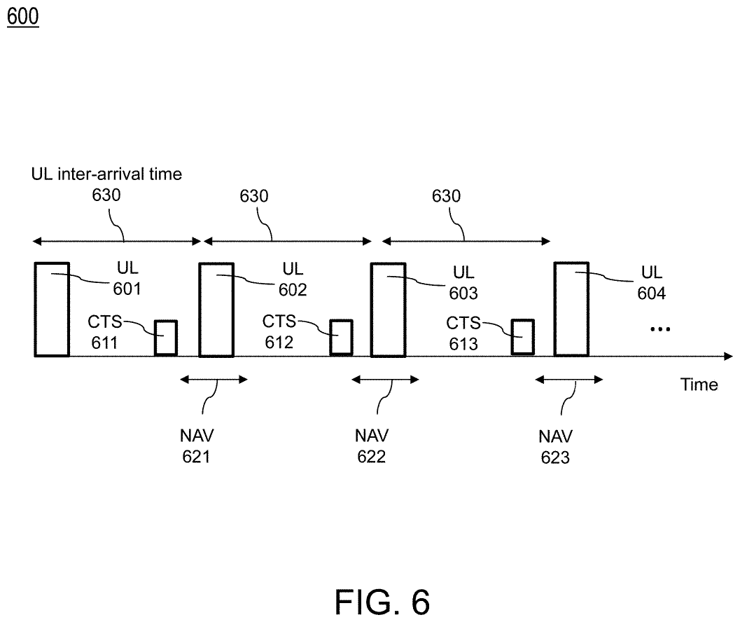

FIG. 6 is a diagram depicting a scheme for scheduling communication for remote rendering from an AR/VR console (e.g., console 404, AP/console 454) to an AR/VR device (e.g., device 406, 456), according to an example implementation of the present disclosure. FIG. 6 shows a scheduling scheme 600 in a second scenario in which when DL data (not shown in FIG. 6) and UL data 601, 602, 603, 604 (e.g., data transmitted by device 406, 456 to console 404, 454) are independent from each other such that transmission of the UL data may not overlap nor be close to transmission of the DL data, the console may transmit a clear-to-send (CTS) frame 611, 612, 613, 614 or a CTS-to-self frame to the AR/VR device to avoid collision/contention of the device with other STAs for data transmissions or channel access. For example, the inter-arrival time 630 of UL data (e.g., sensor measurement data or pose/IMU data) may be 2 ms (500 Hz) in a manner that transmission of the UL data is independent with transmission of DL data.

In some embodiments, in a case in which the console and AR/VR devices share a wireless medium or channel in a basic service set (BSS), the console (e.g., soft AP) may send a CTS frame 611, 612, 613 or a CTS-to-self frame, with a receiver address (RA) that is set to an address of a particular/target AR/VR device (e.g., device 406 in FIG. 4A) only, to quiet the BSS. For example, upon sending a CTS frame or a CTS-to-self frame, other devices (e.g., device 408 in FIG. 4A) in the vicinity except the particular/target device (e.g., device 406 in FIG. 4A) cannot access the shared channel/medium, so as to avoid collision/contention between devices for transmissions and/or channel access. In some embodiments, the console may transmit a CTS frame 611 or a CTS-to-self frame to reserve a time period (e.g., an expected time period) for the particular/target device to transmit sensor measurement data by indicating the time period in a NAV 621. The CTS frame or the CTS-to-self frame may include a specific address of the particular/target device as a receiver address (RA), such that other devices would remain quiet and not transmit for the time period. Hence, the particular/target device may transmit the sensor measurement data (e.g., UL data 602) during the time period indicated by NAV 621 without competing/contending with other devices.

Referring to FIG. 4A and FIG. 6, in some embodiments, a head wearable device (HWD) 406 (or HWD 456) may include one or more processors (e.g., processing unit 316 in FIG. 3). The one or more processors may be configured to receive, from a console 402 (or console 454), HE MU PPDU 561 including image data 501 of artificial reality and a trigger frame 551, the trigger frame 551 including an identifier (e.g., AID 552) identifying the HWD 406 (or HWD 456). The one or more processors may be configured to transmit, to the console, sensor measurement data 512 indicating a location or orientation of the HWD, in response to the identifier 552 identifying the HWD 406 in the trigger frame 551. In some embodiments, the trigger frame 551 may include the identifier 552 identifying only the HWD 406. Only the HWD 406 may be configured to transmit the sensor measurement data 552, in response to the trigger frame 551.

In some embodiments, the one or more processors may be configured to transmit different sensor measurement data 513, 514, 515, 516, 517 periodically according to a first time interval 522. The console 402 may be configured to transmit HE MU PPDUs including different image data (e.g., DL data 502) periodically according to a second time interval 520, the second time interval 520 being larger than the first time interval 522. In some embodiments, the HWD may be configured to receive the HE MU PPDU (e.g., PPDU 551 including DL data 501) during a time duration (e.g., SP duration 541) between i) a first time duration for the one or more processors to transmit additional sensor measurement data 511 and ii) a second time duration for the one or more processors to transmit the sensor measurement data 512.

In some embodiments, a HWD 406 (or HWD 456) may include one or more processors (e.g., processing unit 316 in FIG. 3). The one or more processors may be configured to receive, from a console 402 (or console 454), a clear-to-send (CTS) frame 611 including an address of the HWD 406. The one or more processors may be configured to transmit, to the console 402, sensor measurement data 602 indicating a location or orientation of the HWD, in response to the address of/specifying the HWD in the CTS frame 611. The CTS frame 611 may include the address of the HWD as a receiver address (RA). The CTS frame 611 may prevent other devices (e.g., HWD 408) from transmitting while the HWD 406 transmits sensor measurement data 602 to the console (e.g., during the time period indicated by NAV 621).

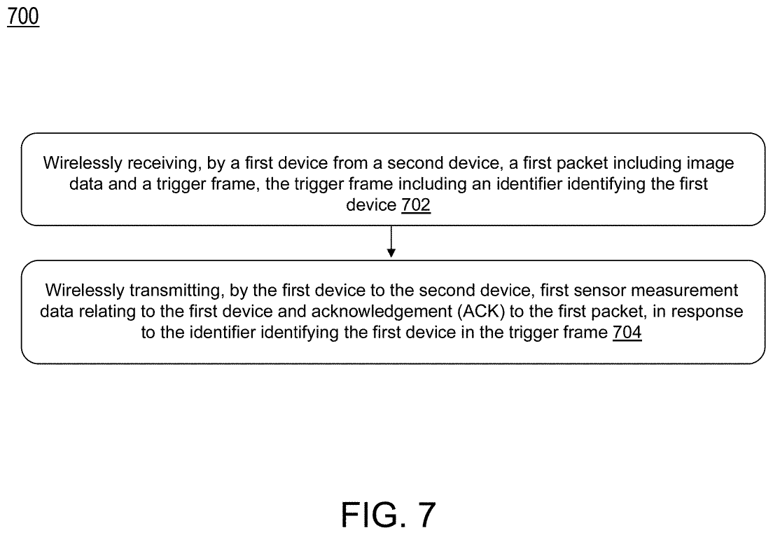

FIG. 7 is a flowchart showing a process 700 of remote rendering from a console (e.g., console 402, 454) to an AR/VR device (e.g., HWD 406, 456), according to an example implementation of the present disclosure. In some embodiments, the process 700 is performed by a first device (e.g., HWD 406, 456). In some embodiments, the process 700 is performed by other entities. In some embodiments, the process 700 includes more, fewer, or different steps than shown in FIG. 7.

In one approach, the first device may wirelessly receive 702, from a second device (e.g., console 402, 454), a first packet (e.g., PPDU 561) including image data (e.g., DL data 501) and a trigger frame (e.g., trigger frame 551), the trigger frame including an identifier (e.g., AID 552) identifying the first device. In some embodiments, the first device may communicate with the second device using a peer-to-peer connection in a wireless network (e.g. peer-to-peer network, Wi-Fi Direct). In some embodiments, the first packet may be a high efficiency multi-user physical protocol data unit (HE MU PPDU) 561. The trigger frame 551 may include a resource unit (RU) 553 associated with the identifier 552, such that the first device is triggered to transmit the first sensor measurement data 512 in the RU 553.

In one approach, the first device may wirelessly transmit 704, to the second device, first sensor measurement data (e.g., UL data 512) relating to the first device and acknowledgement (ACK) to the first packet, in response to the identifier 552 identifying the first device in the trigger frame 551. In some embodiments, the first device may be a HWD (e.g., HWD 406, 456) and the second device may be a console device (e.g., console 402, 454). In some embodiments, the first sensor measurement data may indicate a location or orientation of the HWD (e.g., pose/IMU data).

In some embodiments, the first device may perform the wirelessly receiving and the wirelessly transmitting in a (single) service period (e.g., SP 541, 543) of a TWT schedule (e.g., TWT schedule 540, 542). The first device may determine the service period, to operate the first device in a wake up mode, the service period encompassing a first duration (e.g., duration 530) to wirelessly receive the first packet and a second duration (e.g., duration 532) to wirelessly transmit the first sensor measurement data. Prior to receiving the first packet, the first device may enter the wake up mode. The first device may enter a sleep mode after the service period.

In some embodiments, the first device may periodically (e.g., with an interval of DL inter-arrival time 520) receive, from the second device, a plurality of packets (e.g., PPDU 561 including DL data 501, PPDU including DL data 502) including the first packet, each of the plurality of packets including respective image data (e.g., DL data 501, 502) and a respective trigger frame in a respective service period. In response to the respective trigger frame, the first device may transmit, to the second device, respective sensor measurement data (e.g., UL data 512, 517) relating to the first device in the respective service period (e.g., SP 541, 543). The first device may enter the wake up mode during the respective service period.

In some embodiments, the first device may associate to the second device as an access point (e.g., soft AP) in a wireless local area network (WLAN). The first device may wirelessly receive, from the second device, a clear-to-send (CTS) frame (e.g., CTS frame 611) with a receiver address set to an address of the first device. The first device may determine a third duration (e.g., NAV duration 621) indicated in the CTS frame. The first device may wirelessly transmit, to the second device during the third duration, second sensor measurement data (e.g., UL data 602) relating to the first device.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first device comprising:
a transceiver; and
one or more processors configured to:
wirelessly receive, via the transceiver from a second device, a first packet including image data and a trigger frame, the trigger frame including an identifier identifying the first device; and
wirelessly transmit, via the transceiver to the second device, first sensor measurement data relating to the first device and acknowledgement (ACK) to the first packet, in response to the identifier identifying the first device in the trigger frame.

2. The first device according to claim 1, wherein the first device is a head wearable device (HWD) and the second device is a console device.

3. The first device according to claim 2, wherein the first sensor measurement data indicates a location or orientation of the HWD.

4. The first device according to claim 1, wherein the transceiver is configured to communicate with the second device using a peer-to-peer connection in a wireless network.

5. The first device according to claim 1, wherein
the wirelessly receiving and the wirelessly transmitting are performed in a service period of a target wake time (TWT) schedule, and the one or more processors are configured to:
determine the service period, to operate the first device in a wake up mode, the service period encompassing a first duration to wirelessly receive the first packet and a second duration to wirelessly transmit the first sensor measurement data;
prior to receiving the first packet, enter the first device in the wake up mode; and
after the service period, enter the first device in a sleep mode.

6. The first device according to claim 5, wherein the one or more processors are configured to:
periodically receive, from the second device, a plurality of packets including the first packet, each of the plurality of packets including respective image data and a respective trigger frame in a respective service period;
in response to the respective trigger frame, transmit, to the second device, respective sensor measurement data relating to the first device in the respective service period; and
enter the first device in the wake up mode during the respective service period.

7. The first device according to claim 1, wherein the first packet is a high efficiency multi-user physical protocol data unit (HE MU PPDU).

8. The first device according to claim 7, wherein the trigger frame includes a resource unit (RU) associated with the identifier, such that the first device is triggered to transmit the first sensor measurement data in the RU.

9. The first device according to claim 1, wherein the one or more processors are configured to associate the first device to the second device as an access point in a wireless local area network (WLAN).

10. The first device according to claim 9, wherein the one or more processors are configured to:
wirelessly receive, via the transceiver from the second device, a clear-to-send (CTS) frame with a receiver address set to an address of the first device;
determine a third duration indicated in the CTS frame; and
wirelessly transmit, via the transceiver to the second device during the third duration, second sensor measurement data relating to the first device.

11. A method comprising:
wirelessly receiving, by a first device from a second device, a first packet including image data and a trigger frame, the trigger frame including an identifier identifying the first device; and
wirelessly transmitting, by the first device to the second device, first sensor measurement data relating to the first device and acknowledgement (ACK) to the first packet, in response to the identifier identifying the first device in the trigger frame.

12. The method according to claim 11, wherein the first device is a head wearable device (HWD) and the second device is a console device.

13. The method according to claim 12, wherein the first sensor measurement data indicates a location or orientation of the HWD.

14. The method according to claim 11, wherein the first device communicates with the second device using a peer-to-peer connection in a wireless network.

15. The method according to claim 11, wherein the wirelessly receiving and the wirelessly transmitting are performed in a service period of a target wake time (TWT) schedule, and the method further comprises:
determining the service period, to operate the first device in a wake up mode, the service period encompassing a first duration to wirelessly receive the first packet and a second duration to wirelessly transmit the first sensor measurement data;
prior to receiving the first packet, entering the wake up mode; and
after the service period, entering a sleep mode.

16. The method according to claim 15, further comprising:
periodically receiving, by the first device from the second device, a plurality of packets including the first packet, each of the plurality of packets including respective image data and a respective trigger frame in a respective service period;
in response to the respective trigger frame, transmitting, by the first device to the second device, respective sensor measurement data relating to the first device in the respective service period; and
entering the wake up mode during the respective service period.

17. The method according to claim 11, wherein the first packet is a high efficiency multi-user physical protocol data unit (HE MU PPDU).

18. The method according to claim 17, wherein the trigger frame includes a resource unit (RU) associated with the identifier, such that the first device is triggered to transmit the first sensor measurement data in the RU.

19. The method according to claim 11, further comprising:
associating, by the first device, to the second device as an access point in a wireless local area network (WLAN).

20. The method according to claim 19, further comprising:
wirelessly receiving, by the first device from the second device, a clear-to-send (CTS) frame with a receiver address set to an address of the first device;
determining, by the first device, a third duration indicated in the CTS frame; and
wirelessly transmitting, by the first device to the second device during the third duration, second sensor measurement data relating to the first device.
